(19) United States
(12) Patent Application Publication
(10) Pub. No.: US 2011/0304735 A1
(43) Pub. Date: Dec. 15, 2011

(54) Method for Producing a Live Interactive Visual Immersion Entertainment Show

(76) Inventor: Lon VAN EATON, Castle Rock, CO (US)

(21) Appl. No.: 13/160,401

(22) Filed: Jun. 14, 2011

Related U.S. Application Data
(60) Provisional application No. 61/354,329, filed on Jun. 14, 2010.

(51) Int. Cl. H04N 7/18

(52) U.S. Cl. 348/159; 348/E07.085

(57) ABSTRACT

A media system for providing audience with a fully immersed experience that integrates virtual scenes with live physical scenes. The media system utilizes a special set to perform a live performance. The performance is recorded, while simultaneously being projected onto a projection surface for audience viewing. The projection is processed to include a virtual environment and allows the audience to have an immersed and profound experience. The present invention provides audiences with a feeling as if they were part of the scene.

The current application claims a priority to the U.S. Provisional Patent application Ser. No. 61/354,329 filed on Jun. 14, 2010.

### FIELD OF THE INVENTION

The present invention relates generally to a media system that combines film, live theatre, live entertainment, multi-media and streaming content. It is the objective of the present invention to provide audiences a more profound, emotionally intense and immersive entertainment experience.

### BACKGROUND OF THE INVENTION

Traditional theatre experiences allow audiences to view a pre-recorded and edited film or live theatre acting. However, these forms of entertainment still separate the audience from the events of the act or film. By separating the audience from the events of the act or film, the audiences are provided with an outsider's view. As a result, the audiences are unable to fully appreciate the emotions and atmosphere being conveyed by the act or film. The present invention overcomes the short comings of the traditional theatre experience by introducing a media system that allows audiences to immerse themselves into the scene of an live theatrical performance. As a result, the audience is immersed within the experience and feeling as if they are part of the scene themselves.

### BRIEF DESCRIPTION OF THE DRAWINGS

FIG. 1 is a schematic of the present invention showing the different components and actions being performed in separate domes.

FIG. 2 is the view of main dome and the performance dome with the audience entering through the ticket booth dome.

FIG. 3 is another embodiment of the present invention where the projection surface is a flat screen. The diagram shows the set where the performance is being performed being hidden from the audience.

FIG. 4 is the embodiment of the present invention where the projection surface is a dome. The present invention utilizes a multi array of cameras to provide a full projection for an entire dome projection surface. This embodiment of the invention provides audiences with a fully immersed experience.

FIG. 5 shows how the present invention operates transmitting the recording of the scene to the computing switch device and to the projector.

### DETAIL DESCRIPTIONS OF THE INVENTION

All illustrations of the drawings are for the purpose of describing selected versions of the present invention and are not intended to limit the scope of the present invention.

The present invention is a media system that utilizes a plurality of cameras 1, a plurality of set screen panels 2, a sensor grid 8, a computing switch device 3, a projection surface 4, at least one projector 5, a plurality of speakers 7 positioned inside a main dome 10 and a performance dome 11. The present invention integrates recorded media, streaming media, multi-media sources with live media to fuse film and multi-media together with live theatre and live entertainment.

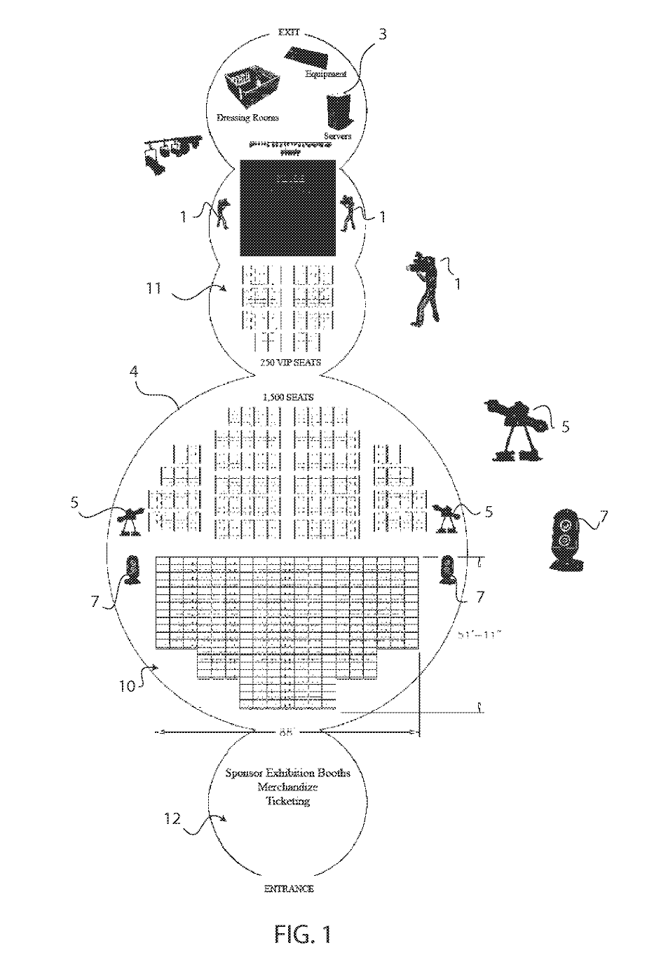

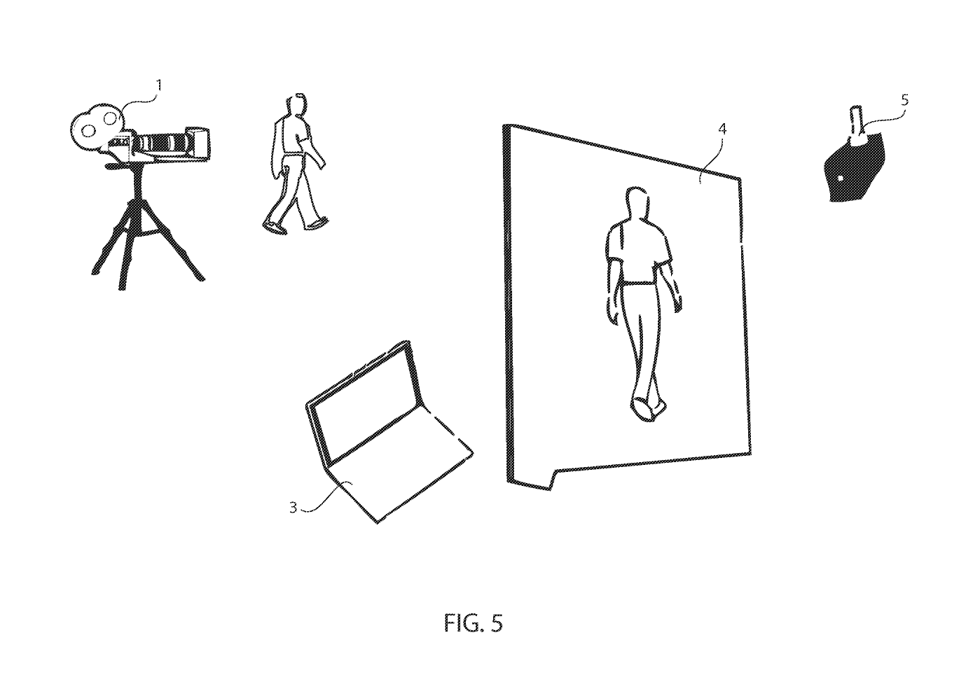

In reference to FIG. 1 and FIG. 5, the present invention is performed and executed inside the main dome 10 and the performance dome 11. The performance dome 11 is a space provided for the performance of a live entertainment performance. The live entertainment performance can be any form of entertainment from musical orchestra performances, musical solo performances, live theatres, dance and any other suitable form of entertainment. The live performance is performed in front of a plurality of set screen panels 2. The plurality of set screen panels 2 have a consistent predetermined color. In the preferred embodiment of the present invention, the plurality of set screen panels 2 are green screens. In other embodiments of the present invention, the plurality of set screen panels 2 can be blue screens or any other suitable color. The live performance is performed in front of the plurality of set screen panels 2 and under the sensor grid 8. The live performance is recorded by the plurality of cameras 1. The plurality of cameras 1 are positioned around and directed towards the plurality of set screen panels 2 to provide different angles of view for the audience viewing the performance. The recording of the live performance is transmitted to the computing switch device 3 and displayed onto the projection surface 4 by the at least one projector 5. The transmission of the recording can be transmitted through cables or by wireless data transfer from the plurality of cameras 1 to the computing switch device 3 to the at least one projector 5. During the performance, as the actors performing the live performance or performance are moving in front of the plurality of set screen panels 2 and under the sensor grid 8. The plurality of physical props 6 are set up in front of the plurality of set screen panels 2 as well to allow the actors to interact with the environment. When the scene is recorded by the plurality of cameras 1 and transmitted to the computing switch device 3, the recorded scenes are processed to render the predetermined colors into an three dimensional environmental image. The computing switch device 3 is an electronic device that utilizes high capacity computer with software to separate or combine various feeds from the plurality of cameras 1 and multiple media feeds to be projected by the at least one projector 5. The feeds to the at least one projectors 5 and the plurality of speakers 7 for the audience can be sourced directly from the microphones and cameras 1 recorded from the live performance and can also be sourced from pre-recorded videos and audio. The fusion of the live performance with pre-recorded multimedia provides the audiences with an even more unique fully immersed experience. The environmental image is blended with a plurality of physical props 6 to provide a fusion between the variety of physical and digital environment. As a result, the performance is provided with the versatility and freedom to quickly create different scenes with different environments. For example, the plurality of set screen panels 2 in combination with the proprietary software can provide a virtual set which could be a “star field”. Resultantly, when the scene is projected and displayed for the audience to view, an actor in the live performance will appear to be in the star field. In addition to the live performance, pre-recorded film may also be projected into the main dome 10 in combination with the recorded live performance. The combination of the live action theatrical scenes and pre-recorded film is seamless and provides a great transition from scene to scene and allow for a quick set up of the props 6 for the following scene. The present invention provides the audience with an experience of multiple media in real-time including live action theatre, recorded media (film, video, etc.), and social media (Facebook, Twitter, and MySpace). All media is projected for the audience in the main dome 10 and is interactive for audience participation in the creation of the content.

The user controlling the computing switch device 3 is able to switch scene angles of view that are being projected onto the projection surface 4. However, with changing scene angles, the digital environmental image provided by the computing switch device 3 is required to correspondingly provide a different angle of the environment for a more realistic scene. Utilizing the sensor grid 8 above the live performance, the media system is able to more accurately follow the entertainers or the focus of the scene to provide a consistent computer generated environment. The sensor grid 8 provides a smooth transition from camera to camera and prevents distortions in the image being projected by the projector 5 onto the projection surface 4. Each camera is activated by the sensor grid 8 depending on the positioning of the performers or the focus area of the live performance and the projection surface 4. Different settings can be used depending on the projection surface 4. The projection surface 4 is a surface for viewing the projections of the live performance that can be a screen, or an main dome 10. In the preferred embodiment of the present invention, the projection surface 4 is the ceiling of the main dome 10. The main dome 10 is the encompassing dome that completely surrounds the audience viewing the live performance.

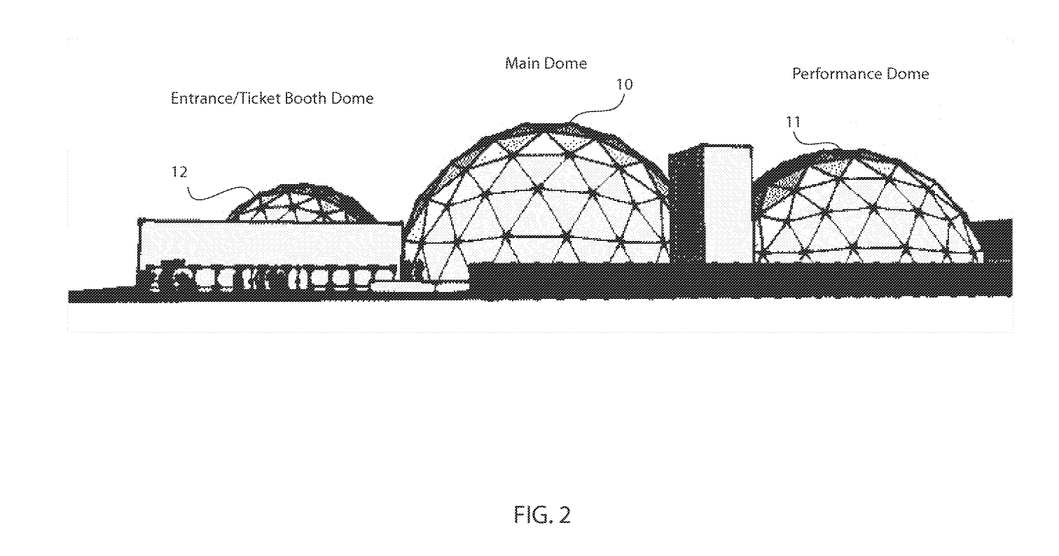

In reference to FIG. 2, to project the live performance onto the encompassing dome projection surface 4, the present invention utilizes a multi camera array with the plurality of cameras 1 and feeds to provide a more profound experience for the audience. In the embodiment where an encompassing dome is used as the projection surface 4, the projection may utilize more than one camera to provide a complete environmental view of the live performance. Each of the cameras 1 are synchronized to each other by the sensor grid 8 to allow the live performance to be recorded at differing angles for complete dome projection. The recorded images are transmitted to the computing switch device 3 which are then combined and transmitted to a plurality of projectors 5. The plurality of projectors 5 are dispersed about the main dome 10 to provide even projection throughout the entire encompassing dome projection surface 4 of the main dome 10. The projectors 5 translates the signal from the computing switch device 3 to be displayed. Each of the projectors 5 are able to project a section of the entire image, to provide the complete immersed experience to the audience. By utilizing the image being recorded by the plurality of cameras 1, the audience is provided with completely immersed and profound experiences. As a result, the audience is able to experience the scene as if they were in the scene themselves. In addition to the visual component of the plurality of projectors 5, a plurality of speakers 7 are dispersed about the main dome 10 to provide a surround sound atmosphere. The addition of a surround sound system provides an even more profound immersed experience for the audience.

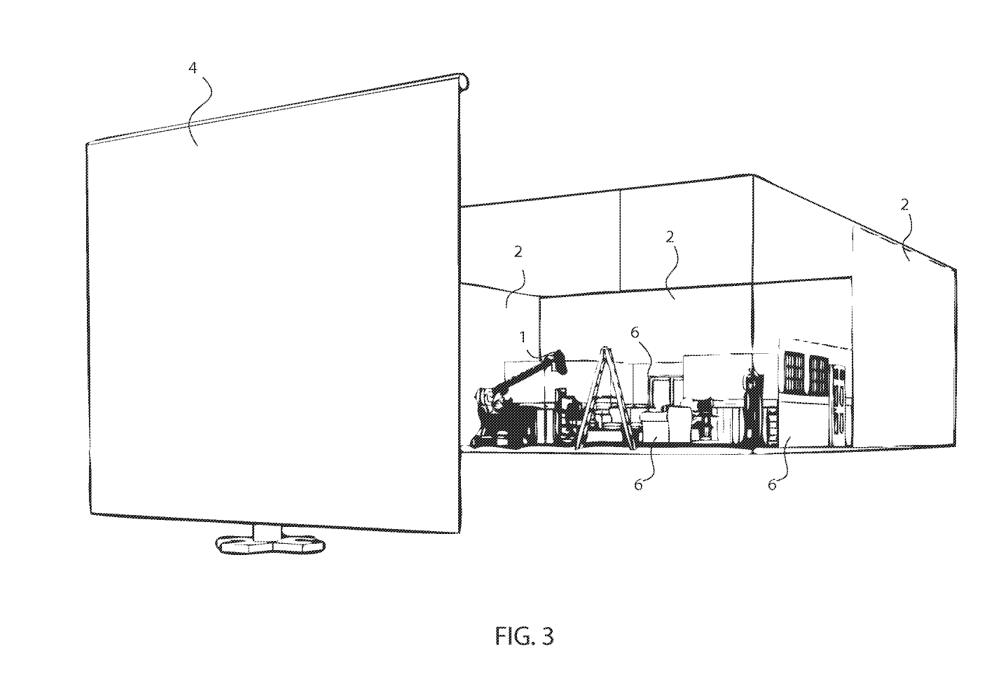

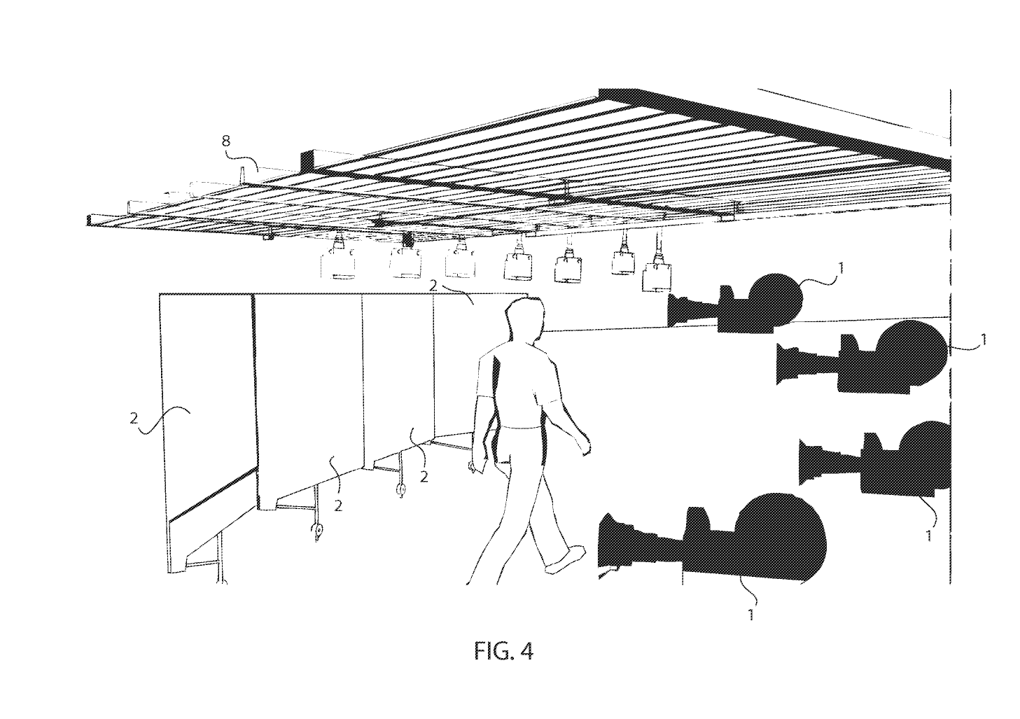

In reference to FIG. 3 and FIG. 4, the actors who are performing in the live performance are not directly seen by the audience. The actors and the set of the live performance are positioned in a performance dome 11 that is separated from the audience. Additionally, as audience is only able to see what is displayed on the encompassing dome projection surface 4, the scene can be seamlessly cut between live action and pre-recorded action. As a result, the present invention provides a true integration of live theatre with film and multiple media sources. In other methods, the actors are able to enter the main dome 10 to interact the audience to authorize that the live performance is indeed live.

Providing a ticketing booth 12 dome that is connected with the main dome 10, the audience is able to view the live theatrical plays by purchasing tickets. The ticketing booth 12 dome allows the operators of the live theatre to sell tickets. The tickets provides the audience with permission to enter the main dome 10 to experience the live theatre performance.

Although the invention has been explained in relation to its preferred embodiment, it is to be understood that many other possible modifications and variations can be made without departing from the spirit and scope of the invention as hereinafter claimed.

What is claimed is:

1. A method for producing a live interactive visual immersion entertainment show comprises,
providing a plurality of cameras, a plurality of set screen panels, a sensor grid, a computing switch device, a projection surface, at least one projector, a plurality of physical props, and a plurality of speakers;
recording of a live performance in front of the plurality of set screen panels and under the sensor grid by the plurality of cameras;
projecting the live performance from the plurality of cameras through the computing switch device onto a projection surface by means of the at least one projector;
providing a computer generated environment for the live performance by the computing switch device for projection by the at least one projector;
switching of scene angles by the computing switch device; and
providing consistent computer generated environment by the sensor grid and the computing switch device.

2. The method for producing a live interactive visual immersion entertainment show as claimed in claim 1 comprises,
wherein the projection by the at least one camera includes feeds from pre-recorded multi-media, live video performances, and live audio performances; and
wherein the projection surface is a surface for viewing selected from the group consisting of a screen, and a main dome.

3. The method for producing a live interactive visual immersion entertainment show as claimed in claim 1 comprises,
activating of the plurality of cameras by the sensor grid to expose various angles depending on the projection surface; and
dispersing the plurality of speakers, wherein the speakers provides a surround sound atmosphere.

4. The method for producing a live interactive visual immersion entertainment show as claimed in claim 1 comprises,
wherein the live performance is performed in a performance dome; and
wherein the projecting of the live performance by the at least one projector is executed and viewed in a main dome.

5. The method for producing a live interactive visual immersion entertainment show as claimed in claim 1 comprises,
providing a ticketing booth; and
selling of tickets in the ticketing booth, wherein the tickets provides permission to view the theatrical performance.

6. The method for producing a live interactive visual immersion entertainment show as claimed in claim 1 comprises,
wherein the plurality of set screen panels have a predetermined color; and
rendering of the predetermined color of the recording by the plurality of the cameras into an environmental image, wherein the environmental image is blended with the plurality of physical props for projection.

7. The method for producing a live interactive visual immersion entertainment show as claimed in claim 1 comprises,
wherein the live performance is a live entertainment performance selected from the group consisting of live theater, musical theater, musical acts, operas, musical instruments performances, singing performances, and dance performances.

8. A method for producing a live interactive visual immersion entertainment show comprises,
providing a plurality of cameras, a plurality of set screen panels, a sensor grid, a computing switch device, a projection surface, at least one projector, a plurality of physical props, and a plurality of speakers;
recording of a live performance in front of the plurality of set screen panels and under the sensor grid by the plurality of cameras;
projecting the live performance from the plurality of cameras through the computing switch device onto a projection surface by means of the at least one projector;
providing a computer generated environment for the live performance by the computing switch device for projection by the at least one projector;
switching of scene angles by the computing switch device;
providing consistent computer generated environment by the sensor grid and the computing switch device;
activating of the plurality of cameras by the sensor grid to expose various angles depending on the projection surface; and
dispersing the plurality of speakers, wherein the speakers provides a surround sound atmosphere.

9. The method for producing a live interactive visual immersion entertainment show as claimed in claim 8 comprises,
wherein the projection by the at least one camera includes feeds from pre-recorded multi-media, live video performances, and live audio performances;
wherein the projection surface is a surface for viewing selected from the group consisting of a screen, and a main dome;
wherein the live performance is performed in a performance dome; and
wherein the projecting of the live performance by the at least one projector is executed and viewed in a main dome.

10. The method for producing a live interactive visual immersion entertainment show as claimed in claim 8 comprises,
providing a ticketing booth; and
selling of tickets in the ticketing booth, wherein the tickets provides permission to view the theatrical performance.

11. The method for producing a live interactive visual immersion entertainment show as claimed in claim 8 comprises,
wherein the plurality of set screen panels have a predetermined color; and
rendering of the predetermined color of the recording by the plurality of the cameras into an environmental image, wherein the environmental image is blended with the plurality of physical props for projection.

12. The method for producing a live interactive visual immersion entertainment show as claimed in claim 8 comprises,
wherein the live performance is a live entertainment performance selected from the group consisting of live theater, musical theater, musical acts, operas, musical instruments performances, singing performances, and dance performances.

13. A method for producing a live interactive visual immersion entertainment show comprises,
providing a plurality of cameras, a plurality of set screen panels, a sensor grid, a computing switch device, a projection surface, at least one projector, a plurality of physical props, and a plurality of speakers;
recording of a live performance in front of the plurality of set screen panels and under the sensor grid by the plurality of cameras;
projecting the live performance from the plurality of cameras through the computing switch device onto a projection surface by means of the at least one projector;
providing a computer generated environment for the live performance by the computing switch device for projection by the at least one projector;
switching of scene angles by the computing switch device;
providing consistent computer generated environment by the sensor grid and the computing switch device;
activating of the plurality of cameras by the sensor grid to expose various angles depending on the projection surface;
dispersing the plurality of speakers, wherein the speakers provides a surround sound atmosphere;
wherein the plurality of set screen panels have a predetermined color; and
rendering of the predetermined color of the recording by the plurality of the cameras into an environmental image, wherein the environmental image is blended with the plurality of physical props for projection.

14. The method for producing a live interactive visual immersion entertainment show as claimed in claim 13 comprises,
wherein the projection by the at least one camera includes feeds from pre-recorded multi-media, live video performances, and live audio performances;
wherein the projection surface is a surface for viewing selected from the group consisting of a screen, and a main dome;
wherein the live performance is performed in a performance dome; and
wherein the projecting of the live performance by the at least one projector is executed and viewed in a main dome.

15. The method for producing a live interactive visual immersion entertainment show as claimed in claim 13 comprises,
providing a ticketing booth; and
selling of tickets in the ticketing booth, wherein the tickets provides permission to view the theatrical performance.

16. The method for producing a live interactive visual immersion entertainment show as claimed in claim 13 comprises,
wherein the live performance is a live entertainment performance selected from the group consisting of live theater, musical theater, musical acts, operas, musical instruments performances, singing performances, and dance performances.
